(19) United States
(12) Patent Application Publication
(10) Pub. No.: US 2015/0051931 A1
(43) Pub. Date: Feb. 19, 2015

(54) System and Method for Providing Asset Accountability Information

(71) Applicant: Logic-Spot, LLC, Deer Park, TX (US)

(72) Inventors: Candace Miller, Deer Park, TX (US); Aaron Strickland, Dayton, TX (US)

(73) Assignee: Logic-Spot, LLC, Deer Park, TX (US)

(21) Appl. No.: 14/151,996

(22) Filed: Jan. 10, 2014

Related U.S. Application Data
(60) Provisional application No. 61/866,801, filed on Aug. 16, 2013.

(51) Int. Cl. G06Q 10/06

(52) U.S. Cl. CPC G06Q 10/063114; G06Q 10/06311
USPC 705/7.15; 705/7.13

(57) ABSTRACT

Disclosed herein are systems and related methods for providing real-time accountability, including both location and function, for mobile assets such as individuals and equipment associated with various companies or other organizations. A Personnel Accountability Logic (PAL) system in accordance with the disclosed principles uniquely provides for the accounting of personnel and/or equipment location and designated functionality using a publicly available communications network, such as a computer network like the Internet or even a telecommunications network like mobile telephone communications networks. By providing accountability information in real-time across existing publicly available communications networks, a system or method in accordance with the disclosed principles is not hindered by the expense and maintenance of a private, dedicated communications network, nor is its use limited to any one particular company or other organization.

### PRIORITY CLAIM

The present disclosure is a non-provisional conversion of, and thus claims priority to, U.S. Provisional Patent Application No. 61/866,801, filed Aug. 16, 2013, which is herein incorporated by reference in its entirety.

### TECHNICAL FIELD

The present disclosure is related generally to accountability of assets, such as personnel or equipment, and more particularly to a network-based accountability system or method for providing real-time accountability information on assets using a public communications network.

### BACKGROUND

Accounting for personnel at various locations or sites can be useful for any organization hoping to manage those assets efficiently. Such locations or sites can be normal, daily locations, such as a workplace or a school, or they can be one-time sites created at a particular time such as accounting for personnel at the site of an emergency situation. For example, incidents may arise from a natural disaster (i.e., tornado, earthquake, flood, etc.), or emergency situations or accidents (i.e., hazardous material spills, fires, traffic accidents, plane crashes, etc.). Nearly every emergency response entity faces the problems of accounting for its personnel and resources at the scene of such incidents, as well as knowing the status and location of personnel and resources not currently at the scene. Emergency events usually happen at unknown and unplanned locations and thus there is no opportunity to set up equipment ahead of time. Under chaotic conditions, quick response time and data collection accuracy are critical tools.

Such emergency situations create chaotic environments where it can be difficult to track and locate personnel and equipment. For example, to account for its personnel at a scene of an emergency, an emergency response department might require first responders reporting to a scene to report to an incident commander who would assign each first responder to a particular sector of the emergency site. Ideally, the incident commander will decide the sector of the scene to which to assign the first responder based upon the first responder's ability and experience. However, when dealing with a high number of first responders or first responders from other cities or departments, the incident commander may not know the level of training and experience of every reporting first responder. As a result, resources may not be properly or efficiently employed. Additionally, during an incident, a supervisor or commander would ideally know which first responders are assigned to each sector of the emergency site and would also know when and how long the first responders have been located in their assigned sectors. By knowing which personnel are assigned to which sectors, the incident commander can more effectively assign and reassign first responders to the various sectors. Also, if exposure occurs to a first responder, medical personnel may determine how long a particular first responder was exposed to toxic fumes or other elements in a particular area in order to determine the best course of treatment.

With conventional approaches, one manner of keeping such records was to manually maintain a notebook including all of this information. However, such notebooks are impractical to maintain at the scene of an emergency, particularly if things are very hectic. Furthermore, not only does making the necessary entries into the notebook take a substantial amount of time, but the time required to subsequently look up the desired information, or update important information, makes the use of notebooks even more impractical. Inclement weather conditions can also render such paper records damaged or destroyed. Furthermore, if only a single record is kept, providing that information to multiple supervisors becomes troublesome or even impossible. Even if duplicate paper records are created, synchronizing all copies with new and updated information would also be troublesome or impossible.

Even electronic-based accounting systems are limited in their effectiveness. Specifically, conventional electronic records for these situations typically involve establishing a local network using badges, RFID cards, or other similar technology. Generally, tags or other transmitting devices are carried by the personnel or affixed to the equipment and transmit a signal that is received by one or more readers erected at a scene. However, if information regarding users' abilities, training, experience, etc. is to be included, such systems do not allow immediate provision or updating of such information, and instead such information is typically coded to the card or badges far in advance of an incident. Moreover, the costs of setting up and even maintaining such systems, as well as the technical expertise needed on-site, is typically inordinately high. Furthermore, local-based networks like these are not typically adaptable to the scene of a chaotic event because the scene can actually shift during the course of an emergency situation.

Accounting for personnel is in many cases the most crucial need for accountability. Thus, aside from accounting for first responders, other situations would also benefit from accountability information provided for certain personnel. For example, accounting for the presence of employees at the office during required work times allows companies to monitor employee presence and efficiency. Additionally, when workers are needed at various sites apart from their home site, companies would benefit from a system or method that monitors, tracks, and accounts for worker presence at such various locations. In still other situations, if a building is being evacuated, it would be beneficial to know whether all of the workers inside the building have left, as well as where they are presently located. Such situations include where emergency response personnel benefit from the accountability of the affected area, so they know how many people are accounted for and how many are not accounted for, making their rescue efforts more focused on just those victims not accounted for. Such accountability efforts are also beneficial in non-emergency situations, such as fire, disaster, and evacuation drills.

Accordingly, what is needed in the art is a unique system or method for providing real-time accountability of mobile assets, such as personnel and equipment, that does not suffer from the deficiencies found in the prior art. The present disclosure provides such a solution.

### SUMMARY

Disclosed herein are systems and related methods for providing real-time accountability, including both location and function, for mobile assets such as individuals and equipment associated with various companies or other organizations. A Personnel Accountability Logic (PAL) system in accordance with the disclosed principles uniquely provides for the accounting of personnel and/or equipment location and designated functionality using a publicly available communications network, such as a computer network like the Internet or even a telecommunications network like mobile telephone communications networks. By providing accountability information in real-time across existing publicly available communications networks, a system or method in accordance with the disclosed principles is not hindered by the expense and maintenance of a private, dedicated communications network, nor is its use limited to any one particular company or other organization.

In one aspect, asset accountability systems are provided by the disclosed principles. In one embodiment, such an accountability system may include a data center connected to a public communications network and configured to store identification data and accountability data regarding mobile assets of the system in relation to physical locations within an accountability network provided by the system. Each of the assets and locations are geographically remote from the data center. Such a system may also include a unique identifier assigned to each remote asset and to each geographic location, wherein each unique identifier is associated with identifying data corresponding to each remote asset or geographic location. Such a system may also include remote applications running on computing devices configured to communicate using the public communications network and associated with corresponding remote assets or geographic locations. Depending on the embodiment, if a remote application is running on a computing device associated with a remote asset, the remote application is configured to capture a unique identifier associated with a geographic location. However, if a remote application is running on a computing device associated with a geographic location, the remote application is configured to capture a unique identifier associated with a remote asset. In both embodiments, each remote application is further configured to gather accountability data regarding a corresponding remote asset in relation to a geographic location. Such an exemplary system may also have the data center being configured to receive accountability data regarding remote assets from the remote applications across the communications network, and to provide the accountability data across the communications network in response to authorized accountability inquiries regarding remote assets.

In another aspect, methods for providing accountability for assets are also provided by the disclosed principles. In one embodiment, such a method may include storing, at a data center connected to a public communications network, identification data and accountability data regarding mobile assets in relation to physical locations throughout an accountability network. Each of the assets and locations would be geographically remote from the data center. Such an exemplary method may also include assigning a unique identifier to each remote asset and to each geographic location, wherein each unique identifier is associated with identifying data corresponding to each remote asset or geographic location. Such an exemplary method may also include interconnecting with remote applications running on computing devices configured to communicate using the public communications network and associated with corresponding remote assets or geographic locations. Depending on the embodiment, if a remote application is running on a computing device associated with a remote asset, the remote application is configured to capture a unique identifier associated with a geographic location. However, if a remote application is running on a computing device associated with a geographic location, the remote application is configured to capture a unique identifier associated with a remote asset. In both embodiments, such a method may further include gathering accountability data, using the remote applications, regarding a corresponding remote asset in relation to a geographic location. Such a method could also include receiving, at the data center, accountability data regarding remote assets from the remote applications across the communications network, as well as providing, using the data center, the accountability data across the communications network in response to authorized accountability inquiries regarding remote assets.

In yet another aspect, networked accountability systems and related method for providing accountability information for mobile assets associated with a plurality of entities are also provided herein. In one embodiment, an exemplary system may comprise a database connected to a communications network and configured to store accountability data for the mobile assets, where each of the mobile assets have a unique asset identifier assigned, and wherein the database comprises unique location identifiers identifying a plurality of physical locations. In such an embodiment, the system may also include a plurality of applications configured to communicate with the database using the communications network, and to associate one of the unique location identifiers associated with a respective one of the plurality of physical locations with a mobile asset when the mobile asset is located at the respective one of the plurality of physical locations. Furthermore, in such an exemplary system, the database may be configured to receive accountability data regarding the mobile assets from the plurality of applications and to provide the accountability data across the communications network in response to authorized accountability inquiries regarding one or more of the mobile assets.

### BRIEF DESCRIPTION OF THE DRAWINGS

Exemplary embodiments of the disclosed principles are described herein with reference to the following drawings, in which like numerals identify similar components, and in which:

FIG. 1 illustrates an exemplary PAL system in accordance with the disclosed principles, which may be implemented for any number of assets to be accounted for and on behalf of any number of subscribing members;

FIG. 2 illustrates one embodiment of an accountability network established in accordance with the disclosed principles;

FIG. 3 illustrates a diagram demonstrating exemplary embodiments of logging techniques employable with a PAL system as disclosed herein;

FIG. 4 illustrates a screen shot of an exemplary list of subscribers of a PAL system or network in accordance with the disclosed principles;

FIG. 5 illustrates a screen shot of an exemplary list of locations that may be included in a PAL system or network in accordance with the disclosed principles;

FIG. 6 illustrates an exemplary screen shot of specific location information of a particular subscriber of a PAL system or network;

FIG. 7 illustrates a screen shot of an exemplary list of sites within a subscriber's organization that may be included in a PAL system or network in accordance with the disclosed principles;

FIG. 8 illustrates a screen shot of exemplary information regarding a specific site of a subscriber's location;

FIG. 9 illustrates a screen shot of an exemplary list of departments within a subscriber's location or site that may be included in a PAL system or network in accordance with the disclosed principles;

FIG. 10 illustrates an exemplary screen shot of specific department information of a particular subscriber of a PAL system or network;

FIG. 11 illustrates a screen shot of an exemplary list of users within a subscriber's organization that may be included in a PAL system or network in accordance with the disclosed principles;

FIG. 12 illustrates a screen shot of an exemplary list of roles of one or more users within a subscriber's organization that may be included in a PAL system or network in accordance with the disclosed principles;

FIG. 13 illustrates a screen shot of an exemplary list of reasons a user within a subscriber's organization may be found at a given location that may be included in a PAL system or network in accordance with the disclosed principles;

FIG. 14 illustrates a screen shot of exemplary accountability information provided for a given subscriber of a PAL system or network in accordance with the disclosed principles;

FIGS. 15A & 15B illustrate a mobile device running an application for use by a user registered with a PAL system or network in accordance with the disclosed principles, and displaying exemplary Check-In and Check-Out functions of such an application;

FIG. 16 illustrates an exemplary computing device that may be provided at a location or equipment registered with a PAL system in accordance with the disclosed principles;

FIG. 17 illustrates a mobile device running an application for use by a user registered with a PAL system or network in accordance with the disclosed principles, and displaying an exemplary PAL Activation function of the application;

FIG. 18 illustrates a mobile device running an application for use by a user registered with a PAL system or network in accordance with the disclosed principles, and displaying exemplary accountability information of a PAL system via the application;

FIG. 19 illustrates a mobile device running an application for use by a user registered with a PAL system or network in accordance with the disclosed principles, and displaying exemplary settings that may be set by a user of the application; and

FIG. 20 illustrates a mobile device running an application for use by a user registered with a PAL system or network in accordance with the disclosed principles, and displaying an exemplary log having accountability information that may be accessed with the application.

### DETAILED DESCRIPTION

Disclosed herein are systems and related methods for providing real-time accountability, including both location and function, for assets such as individuals and equipment associated with various companies or other organizations. A Personnel Accountability Logic (PAL) system in accordance with the disclosed principles uniquely provides for the accounting of personnel and/or equipment location and designated functionality using a publicly available communications network, such as a computer network like the Internet or even a telecommunications network like mobile telephone communications networks. By providing accountability information in real-time across existing publicly available communications networks, a system or method in accordance with the disclosed principles is not hindered by the expense and maintenance of a private, dedicated communications network, nor is its use limited to any one particular company or other organization.

A PAL system or method in accordance with the disclosed principles would replace or enhance current accountability systems, which typically are limited to sign-in sheets, key cards or other dedicated entry-based devices, and are limited to a single company or site. Thus, accountability of all assets within the PAL system's network may be tracked electronically, and the accountability information easily and immediately available to authorized users and administrators. Moreover, such information is gathered and made available through any available communications network, such as the Internet or a cellular telephone network connection. Even if organizations currently have no system in place, a PAL system as disclosed herein can quickly and easily allow accountability to be tracked from anywhere access to a publicly accessible communications network is available, and at any time, even among unrelated organizations, by simply employing communications devices running application modules configured to work with the PAL system. Moreover, a PAL system as disclosed herein is fully customizable, expandable, and adaptable for almost any use where real-time accountability of personnel and equipment or other objects is advantageous. Further, although publicly accessible networks are employed to transmit accountability or other related data, secured communications, for example, using existing or later developed security protocols may still be implemented, thus ensuring security of transmitted data.

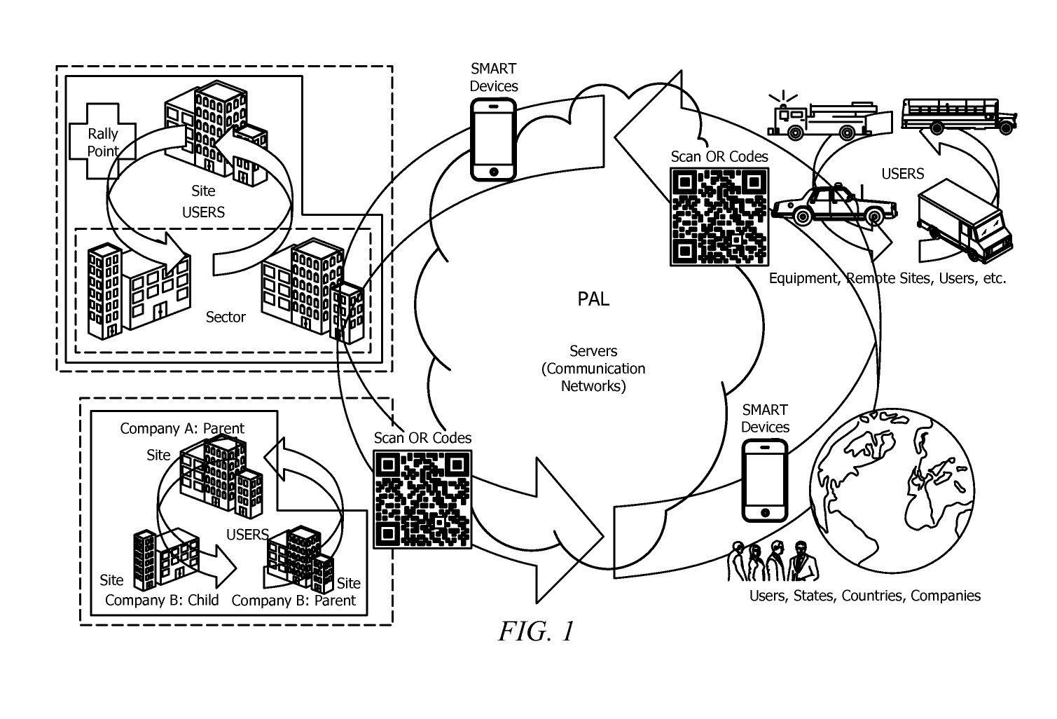

FIG. 1 illustrates an exemplary PAL system in accordance with the disclosed principles, which may be implemented for any number of assets to be accounted for, and on behalf of any number of subscribing members. Exemplary uses, which are discussed in additional detail below, include: Ripple Lists, Rally Points, Safe Zones, tracking of hours spent on a specific job, e.g., at a specific location, tracking movement of personnel or equipment from point A to point B, inventory management, establishing Virtual Locations (such as Shut Downs, Mobile Jobs, Satellite sites, relocating job/work sites), employee time tracking, personal or group sign in/out, incident management, dispatching assets, emergency response accountability of personnel or equipment, child care facilities, and even churches.

FIG. 1 illustrates how versatile a PAL system as disclosed herein is, and may be employed across various companies, locations, sites, equipment and departments within the same company, varying industries, and even distinct countries and states, while implementing existing hardware and communications network(s). As illustrated, smart computing devices and QR codes or other unique identifiers can be employed by the PAL system to any accountability situation the subscribing member desires. This allows the end users (e.g., assets such as personnel or equipment) to be accounted for anywhere and anytime using an existing publicly accessible communication network(s). Additionally, the PAL system saves this information in one or more central data centers (i.e., in the “cloud”) and thus can be provided to any and all users and/or authorized administrators looking to access accountability information on assets. Moreover, since accountability tracking is not limited to a particular subscriber, authorized personnel not affiliated with any particular subscriber, such as first responders, could obtain accountability data on assets associated with any number of unrelated subscribing organizations, etc.

The ability to pull data from a mobile device application makes almost any device employable by a user to access accountability information. The accountability data collected in the data center may also be extrapolated to the user's specific situation and processed to the end user's requirements using customized applications, spreadsheets or other software tools and current technologies. This is a distinct advantage for a PAL system in accordance with the disclosed principles because the PAL system is not limited to just a few uses or functions, or anchored to a specific private network or system, as is the case with conventional systems used for security access or even for accountability purposes. Moreover, a PAL system as disclosed herein is not used in place of a security or other access system, such as key-cards, fobs, or other electronic-based security devices. Rather than providing access to locations, equipment or the like, a PAL system as disclosed herein provides information—information used for the real-time accounting of important assets like persons and equipment.

In specific embodiments, the customization and individual assignment of QR codes or other unique identifiers to targets within the PAL network provides an advantage over conventional systems with the ability to quickly and easily assign a unique identifier to personnel, equipment, locations, objects, areas, groups, geographic areas, and other types of assets or targets. Exemplary targets for which unique identifiers may be created include:
Users—Create a unique identifier for each user by registering their identification information with the PAL system. Users can also be imported on a mass scale using a CSV file.
Companies—Create a unique identifier for each company that subscribes to a PAL system. Companies do not need to be affiliated in order to participate in a PAL network. Accordingly, as users travel between even unrelated companies, a PAL system as disclosed herein can still account for the user's location, etc. even though the two companies are unrelated.
Locations—Create a unique identifier for each of the physical locations of a company.
Sites—Create a unique identifier for each site within a company and/or location. Such sites could be the buildings that are located in each location. For example, sites may have a physical location, using longitude and latitude, which will allow the PAL system to account for assets at a specific site.
Sectors—Create a unique identifier for each sector, which can be used to divide a single site into multiple parts for even more detailed accountability information of assets.
Rally Points—Create a unique identifier for denoted “rally points.” These could be “safe zones” that can be set up inside of a specific location. These may also have a physical location, using longitude and latitude, to allow for detailed accountability information.
Departments—Create a unique identifier for each department within a building. This allows assets to be assigned to, or accounted for, a specific department within a building, site or location.
Ripple List—Create a unique identifier for a “ripple list.” These may be a list of users under other users, and so on. Creating a ripple list allows one person to send out a message to everyone under them, and that message will be sent out to everyone under those users, and so on. Additionally, such messages may be configured to require a response from everyone it went out to, which adds further accountability information to a PAL system.

Unique codes or identifiers created for assets and locations can be immediately updated into the PAL system, and thus the system can immediately begin gathering and providing identifying and accountability information regarding registered, identified assets. Thus, with the continuous communication ability between assets' communications devices (e.g., smart phone, smart device, computer, entry pad, etc.,), accountability information for the personnel, equipment, etc. is updated in the cloud-based data center in real-time when information is gathered via the remote application modules running within the PAL system, even for newly created identifiers. Even as mobile and other computing device technologies evolve, the disclosed PAL system and network easily adapts for use with such new technology, without loss in functionality and availability, since the remote application module need only be updated to work with the new device(s). However, the previously gathered information, whether regarding personnel, equipment, locations, etc. or the accountability of any and all assets of the PAL system, would not be lost or altered, and identification and accountability information can still be gathered and accessed in real-time.

A PAL system generally includes two components—at least one centralized data center and a collection of remote software applications configured to communicate accountability information with the data center across a publicly accessible communications network. As discussed in greater detail below, the data center provides a central collection of accountability data gathered from the collection of remote applications. The data center not only receives the accountability data across an existing communications network, but accountability data stored by the data center may also be accessed by authorized persons using a public communications network. As such, subscribers to the PAL system need not incur the expense of establishing and maintaining a private communications network, and authorized personnel can easily access the accountability data which they are authorized to view using any device with network accessibility.

Implementing a PAL system or method in accordance with the disclosed principles can provide a number of benefits, in a number of different situations. Importantly, the accountability information logged and provided with the disclosed system or method allows the use of commonly available public communications networks, such as the Internet or a wireless telephone communications network. As discussed above, publicly available communications network can be employed through the use of remote application modules installed at registered locations or with registered assets, such as users or equipment. The remote applications communicate with one or more data centers across such public communications networks.

As a result, in both daily situations (e.g., workplaces) and spontaneous situations (e.g., emergency sites), users can check in and out of a location, site, or building, and even provide a reason for being present at or leaving a particular location, site, etc. Other assets, such as equipment, can also be checked in or out of particular locations, and again reasons for the equipment's use at a particular location can also be logged. This allows administrators to account for the location of each user or equipment at particular locations, sites, buildings, etc., such as ensuring employees or machinery or vehicles are present where and when required, and if not then where they actually were, what they were doing there, and for how long. Thus, the network could be used for daily timekeeping of employees, or for tracking personnel travelling between multiple company sites or buildings. In broader applications, personnel may even be accounted for when arriving or leaving locations that are not affiliated with the person's company, such as an unaffiliated company or virtually any location subscribing to the PAL network. Accordingly, the disclosed network can be applied across any number of organizations, companies, etc., even if they are not affiliated, and accountability information made available to each user's respective organization, or to some or all of the subscribing organizations if emergency personnel (e.g., first responders) need to access accountability information.

More specifically, in emergency situations, the disclosed principles allow first responder departments to account for persons and/or equipment within a particular location, site, building etc., and what each person or piece of equipment is doing at that particular location, and even when it will be returned or otherwise available. First responders could also account for personnel present or not present at the response site, such as accounting for people that may be in a burning building or children at a school faced with a dangerous situation. All of this accountability information can be quickly and easily provided to authorized personnel since asset identification and accountability information can be updated via the remote applications over any available network connection. Thus, first responders could arrive at a building or other location during an emergency situation, log in to the PAL network, and account for the persons (or equipment or other assets) present or not present at the location. In other embodiments, first responders could also scan effected persons' unique code for accounting for personnel in the affected area.

In addition to established locations, sites, buildings, etc., the disclosed principles also allow creating a new site immediately at any location, such as at a disaster scene, and personnel at that location could then check in at that site. In addition, a network in accordance with the disclosed principles allows for distributing messages or alerts to users at a particular location, site, building, etc., even if the location or site was recently established. Such messages or alerts may even require responses from some or all users at the particular location, and user responses could then be used to update accountability information in the network. Rally points within a newly established scene could also be quickly established, and users in the area can be directed to check in or out of such points. At either newly established sites or long existing locations, any user authorized to do so could also determine if any other asset is presently at his location or site by simply checking the accountability information provided by the disclosed system or network. All users associated with a location or site can also have their physical location displayed on a map when a site is activated.

These examples are just a few of the beneficial uses provided by the disclosed principles, and no limitation to any particular uses or situations is intended. Thus, additional benefits not expressly discussed herein may also be provided by the disclosed principles. Accordingly, the scope of a PAL system or method as disclosed herein is only limited by claims issuing from this disclosure.

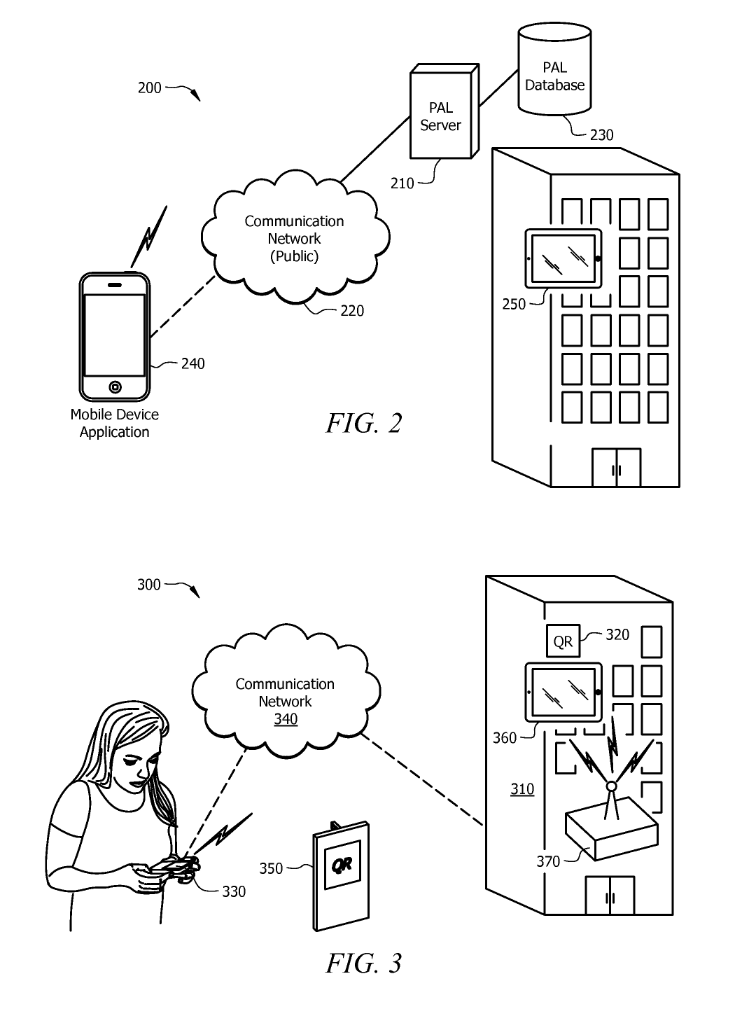

Looking now at FIG. 2, illustrated is one embodiment of an accountability network 200 established in accordance with the disclosed principles. Such an exemplary embodiment includes a data center 210, which is connected to a publicly accessible communications network 220, such as the Internet. Other types of communications networks may also be employed with a system or method of the disclosed principles, such as a telephone communications network or a computer or data network, and no limitation to any particular type of network, or any number of networks used, is intended. Moreover, multiple communications networks may also be employed collectively with the data center 210, to ensure that accountability data is gathered by the data center 210 regardless of the type of devices used to gather the data.

The data center 210 is also illustrated as connected to a database 230. The database 230 may be employed by the data center 210 to store and retrieve accountability data gathered by a PAL system in accordance with the disclosed principles. Although a single database 230 is illustrated, it should be understood that multiple data storage devices may be used with the data center as well. Additionally, such data storage devices may be found in a single location or they may be geographically distributed across multiple locations, as desired. Moreover, although a single data center 210 is illustrated in FIG. 2, multiple data centers may also be implemented with the disclosed principles, if desired. For example, distinct data centers could be employed for different types of accountability data, such as personnel versus equipment. In some embodiments, different data centers may be employed based on geographic regions, such as based on state lines, or may simply be based on the location of subscribers within a predetermined radius of each data center. Multiple data centers may also be employed to provide redundancy for a system in accordance with the disclosed principles, to ensure that access to stored accountability data is always retrievable.

Also illustrated in FIG. 2 are multiple examples of the software application, and associated devices running such applications, that are employable with the data center 210 to provide the accountability data as disclosed herein. In one embodiment, the application may be installed on a mobile device 240, such as a person's mobile telephone. In such embodiments, subscribers to the disclosed PAL system may simply have each of their personnel install such an application on their mobile devices 240 so that those mobile devices 240 can communicate with the data center 210. Examples of how such mobile devices 240 may be employed with the disclosed principles are discussed in detail below.

In addition to installing an application on personnel's mobile devices 240, the disclosed principles also provide for computing devices 250 installed at specific geographic locations, such as specific buildings, areas, departments, or even rooms, associated with organizations subscribing to the PAL system. Such location-specific devices 250 would each have an application installed that is configured to communicate with the data center 210, also as part of the PAL system. Examples of how such location-specific devices 250 may be employed with the disclosed principles are also discussed in detail below.

Looking now at FIG. 3, illustrated is a diagram 300 demonstrating exemplary embodiments of gathering accountability data employable with a PAL system as disclosed herein. As illustrated, specific geographic locations may be provided a unique identifying code or other unique identifier. The identified location may be any structure 310, such as a particular building, perhaps one of many within a larger complex, or may be a piece of machinery or other equipment to be accounted for using the disclosed principles.

In one embodiment of the disclosed principles, the unique identifier, such as a QR code 320, is created for the structure 310. The QR code or other unique identifier 320 would be created by the PAL system for posting at the particular structure 310, and would include linking the code to all the necessary identifying information for that structure 310 or location. Such information could include the address, coordinates, or other location information of the structure 310, as well as any other useful identifying information regarding the structure 310. This identifying information could be stored in a database or other data storage system associated with a data center of the PAL system. In addition, a software application would be installed or otherwise provided on a mobile device 330, such as a cellular telephone. Each of the personnel associated with a subscriber of the PAL system could have such an application on their mobile device 330, and such application would be employed to scan and read the QR code or other unique identifier 320 assigned to the structure 310. By employing a generic format for the unique identifier 320, such as a QR code, the camera in the mobile device 330 of virtually any potential user of the PAL system would be capable of reading the unique identifier 320. Accordingly, there is no need for a specialized scanner or other costly equipment to implement such embodiments of the disclosed principles.

Once the mobile device 330 has read the unique identifier 320, the application of the mobile device 330 is configured to communicate with a data center across a communications network 340. This communication not only provides the data center with information regarding the structure 310 that the user is visiting, but also accountability information such as the date and time of the user's visit, as well as identifying information about the user himself, all transmitted using the mobile device 330. Once the user finishes his visit and is leaving the structure 310, the unique identifier 320 may again be scanned with the mobile device 330, and the application on the mobile device 330 again used to transmit the updated accountability information, such as the time of the user's departure. Moreover, since the user is already associated with the PAL system, the data center could have certain identifying information regarding the user on file as well. Thus, the information on the user can be used in combination with the information on the location he is visiting, and this collective information can also be used, for example, to determine if the user has authority to be in the structure 310 or has only limited access to certain parts of the structure 310, or perhaps even access at only certain times or on certain days. Other exemplary uses for the accountability information gathered and provided by the disclosed principles are discussed in further detail below.

In other embodiments of the disclosed PAL system, a unique identifier may instead be associated with each user, rather than associated with each structure or piece of equipment. For example, a unique QR code 350 could be generated for each user, rather than for the location, and that code 350 could be provided on a badge for the user or could simply be provided digitally for displaying using his mobile device 330. As before, when the unique identifier 350 is established for each user, that information is stored at the data center for later identification when the user's accountability is to be determined. In these embodiments, rather than the user scanning or otherwise reading a unique code 320 with his mobile device 330, a scanner or other reading device 360 is established at the structure 310 that is configured to read the user's unique code 350 when the user visits and later leaves the structure 310. Additionally, rather than the user's mobile device 330 having an application associated with the PAL system, the scanning equipment 360 at the structure 310 may be configured to communicate both the user's information and the structure's information, along with the date and time of the user's visit, as well as any other useful accountability data, to the data center. As before, that collection of data is stored at the data center for use in determining the accountability of the user.

In related embodiments, rather than a unique code 350 being created and assigned to each user, the equipment at the structure 310 may be configured to have an input panel for use by users. In such embodiments, the unique identifier assigned to the user may be simply entered by the user at the panel 360 rather than an identifier being scanned by the panel 360. In some embodiments, the unique identifier may be the user's fingerprint or retinal scan or any other identifier uniquely associated with the user and stored at the data center. No matter the type of identifier, once the user provides his unique identifier, the equipment 360 would still be configured to communicate with the data center to confirm he unique identifier of the user, as well as to provide the accountability information regarding the user to the data center using the communications network 340.

In still other embodiments, a local detection network 370 may be established generally around the perimeter or some portion of the structure 310. Exemplary detection networks 370 could be implemented via local wireless networks, or could also be implemented on a larger scale, such as via a communications network based application like Google® maps (e.g., identification based on latitude/longitude). Of course, any type of detection network using any type of locating technology, may be employed. Such a detection network 370 can be configured to work with any technology capable of detecting when a mobile device 330 is within a predetermined location, such as the structure 310. In such embodiments, the application installed on the mobile device 330 can be configured to detect when it is within the predetermined distance of the structure 310. For example, the application could employ GPS technology of the mobile device 330, as would the location detection network 370, and the application could then communicate accountability information with the data center once it detects that the device 330 is within that distance. Alternatively, the mobile device 330 could be configured to communicate with the detection network 370 once it is within the predetermined distance, and then the detection network 370 could be configured to cause the communication with the data center. The application on the mobile device 330 could also prompt the user to confirm that the user is at the specific location identified by GPS data, as well as the purpose of the visit. Of course, no limitation to the type of detection technology that may be employed with the disclosed principles is intended, and any such technology, either now existing or later developed, may be adapted to function within the scope of the disclosed principles.

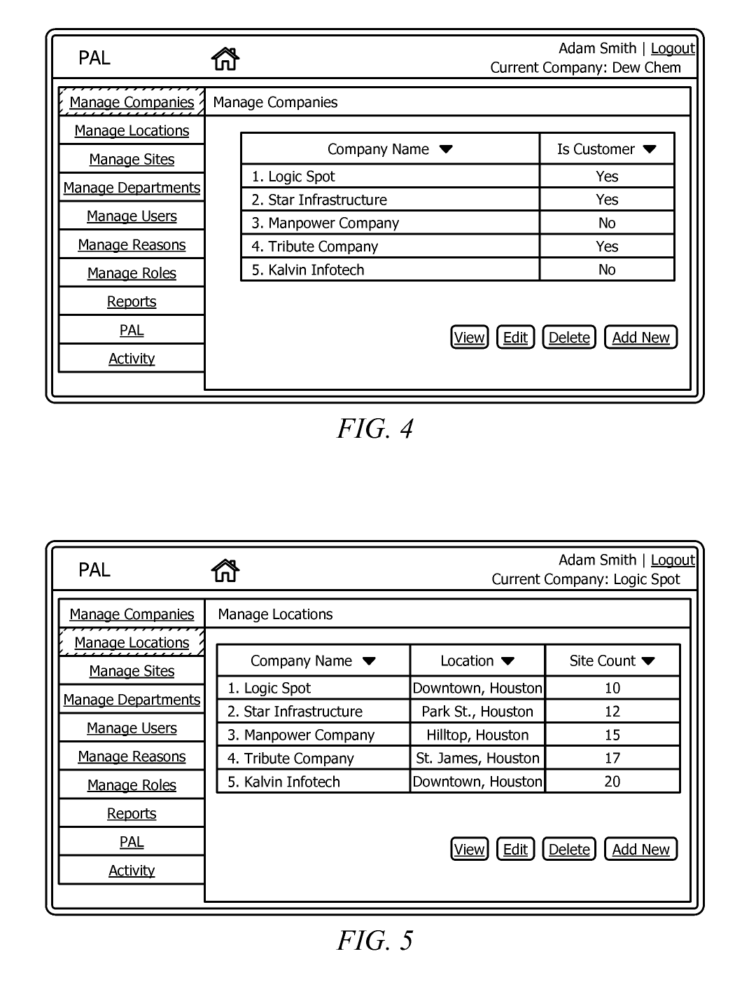

Looking now at FIG. 4, illustrated is a screen shot of an exemplary list of subscribers of a PAL system or network in accordance with the disclosed principles. Such an exemplary screen shot may be provided by software executed at a data center associated with the PAL system, or may be provided on a remote terminal accessible by an administrator or other persons authorized to view the displayed information.

The displayed screen may include various navigation links, which as illustrated may include managing the list of companies, locations, sites, departments, users, reasons, and roles of users of the PAL system. In addition, links may be provided for authorized personnel to access and/or generate reports regarding activities or information of users or subscribers of the PAL system, as well as navigating to a PAL home screen or to view currently ongoing PAL activity within the network. In the illustrated screen shot, a list of companies that are potential subscribers to the PAL system is displayed. Authorized personnel may then scroll through the list of companies to determine which ones are currently subscribing to the PAL system. In addition, such personnel may also add new companies to the list, edit existing information of listed companies, or even delete companies from the list. Other functions for working with the list of companies may also be provided by the PAL system as needed, and these illustrated functions are therefore merely exemplary of potential system functionality.

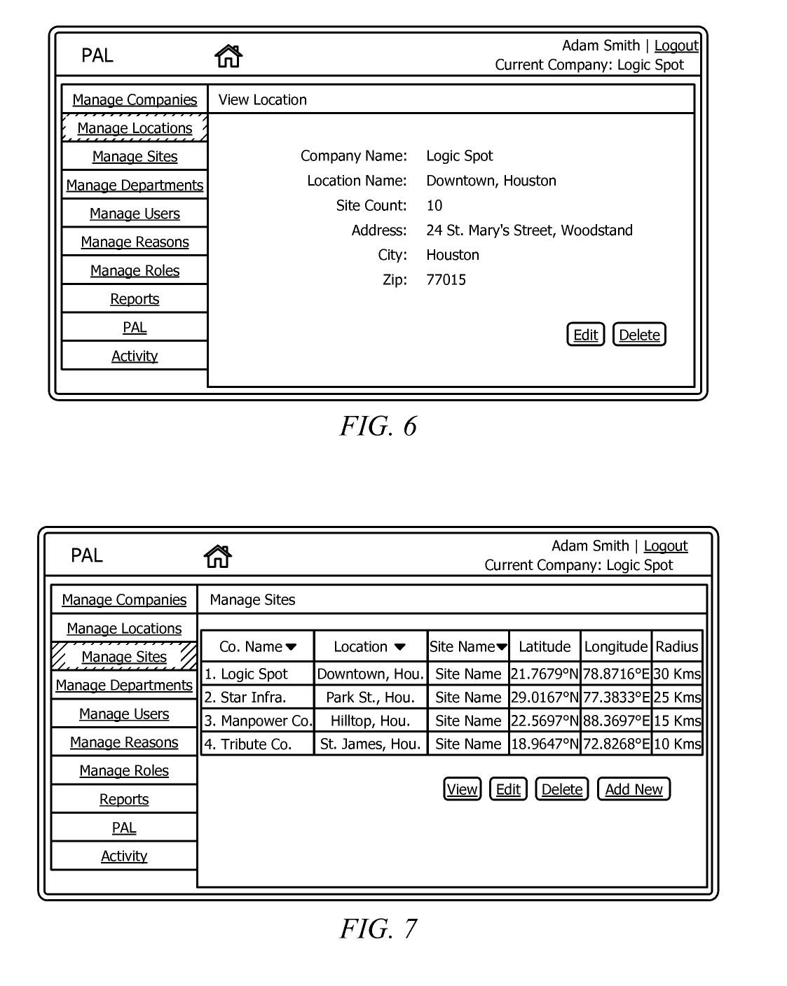

FIG. 5 illustrates a screen shot of an exemplary list of locations that may be included in a PAL system or network in accordance with the disclosed principles. Specifically, once an authorized person selects a company or similar subscriber, information regarding that subscriber may be viewed. In FIG. 5, such information includes displaying the location(s) associated with subscribers. This information may be edited, additional information added, or the location information may be deleted. The accessed location information may be general information such as simply the city and state, which is provided in this embodiment. This general location information may be selectable by the administrator or authorized user, and once selected the PAL system may display more specific location information, such as the physical address. An exemplary screen shot of specific location information of a particular subscriber of a PAL system or network is illustrated in FIG. 6. Additionally, location information may also include the number of sites associated with the subscriber, as illustrated in the screen shot. This site number may be selectable so that a specific list of each site associated with the subscriber is provided.

FIG. 7 illustrates a screen shot of an exemplary list of sites within a subscriber's organization that may be included in a PAL system or network in accordance with the disclosed principles. With regard to the specific site information that may be provided by the disclosed system, the name of each site may be provided, as well as the exact longitude and latitude geographical coordinates information of the site. For example, users can Check In/Out with a mobile device based on entering or leaving a predetermined radius, which may be detected via the device's GPS technology, As before, the site information may be edited, additional information added, or site information may be deleted. In addition, the size of the site, for example, its radius, may also be displayed. Of course, other or alternative site information may also be provided, and thus the information displayed in the screen shot of FIG. 7 is merely exemplary.

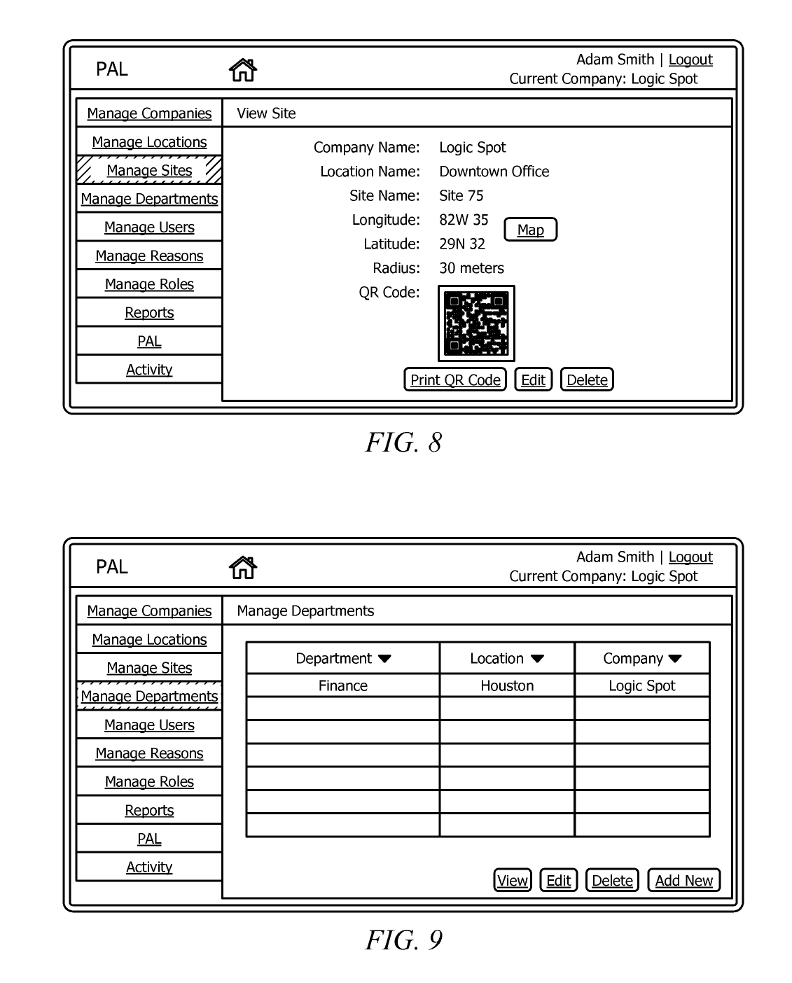

Looking at FIG. 8, illustrated is a screen shot of exemplary information regarding a specific site of a subscriber's location. In particular, when a specific site is selected from the site list, additional details regarding the selected site may be displayed, as illustrated. These details may include the unique identifier, such as a unique QR code, created and assigned for the specific site. Such identifier may also be printed again, such as for a replacement. As before, the site information may be edited, added to, or deleted so that the site information is no longer recognized as part of the PAL system. Also as before, additional or alternative information may also be provided on the site view screen.

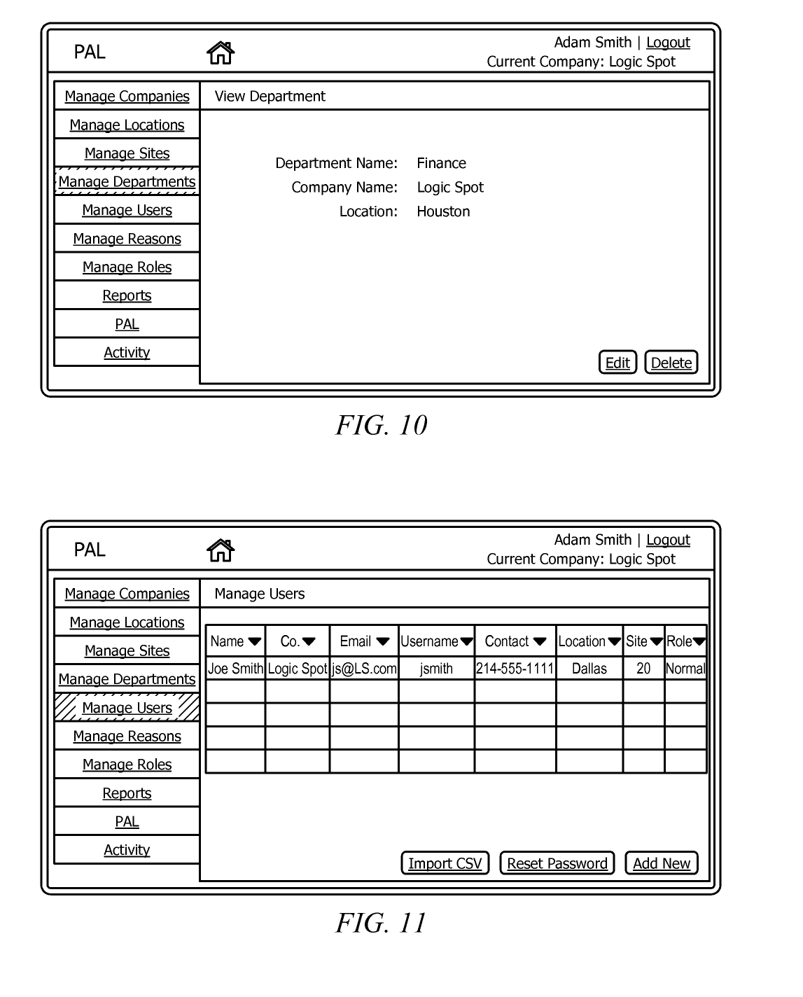

Looking at FIG. 9, illustrated is a screen shot of an exemplary list of departments within a subscriber's location or site that may be included in a PAL system or network in accordance with the disclosed principles. Specifically, once an authorized person selects a company or similar subscriber, as well as selects a specific site of that subscriber, information regarding the various departments associated with the selected site may then be displayed. In accordance with the disclosed principles, departments may be isolated as distinct locations, whether departments are separated into individual buildings at a site, or are within the same building. Accountability of users of the PAL system may therefore be provided for appropriate departments, where desired. As before, the department information may be edited, additional information added, or the information may be deleted. Moreover, distinct departments may also be selected so that the PAL system may display more specific information regarding the selected department. An exemplary screen shot of specific location information of a particular subscriber of a PAL system or network is illustrated in FIG. 10.

Looking at FIG. 11, illustrated is a screen shot of an exemplary list of users within a subscriber's organization that may be included in a PAL system or network in accordance with the disclosed principles. As discussed herein, an asset is typically personnel or equipment associated with a subscriber of the PAL system or network, and therefore such a user list may also be altered to provide a list of equipment or other registered assets. Accountability information for any such user or equipment may be desired by that subscriber, and thus an administrator of the subscriber or the PAL system itself, or another authorized person, may access lists of assets, such as the user list shown in FIG. 11. Displayed asset lists may be limited to only those assets associated with a particular subscriber, or may be further limited to assets pertaining to a particular location, site, or department, if desired. Additionally, the asset list may be a complete list of all assets registered with the PAL system. Such differentiation in accessible asset lists is useful so that when the person accessing the asset list is an administrator for a particular subscriber, the asset list(s) for other subscribing entities are kept confidential from that administrator. Alternatively, if the person accessing the asset list is an administrator of the PAL system, then a complete list of all PAL system assets may be provided, if desired. In either case, asset details may be edited, new assets added, or asset information may be deleted, depending on the level of access provided to the person viewing the particular list.

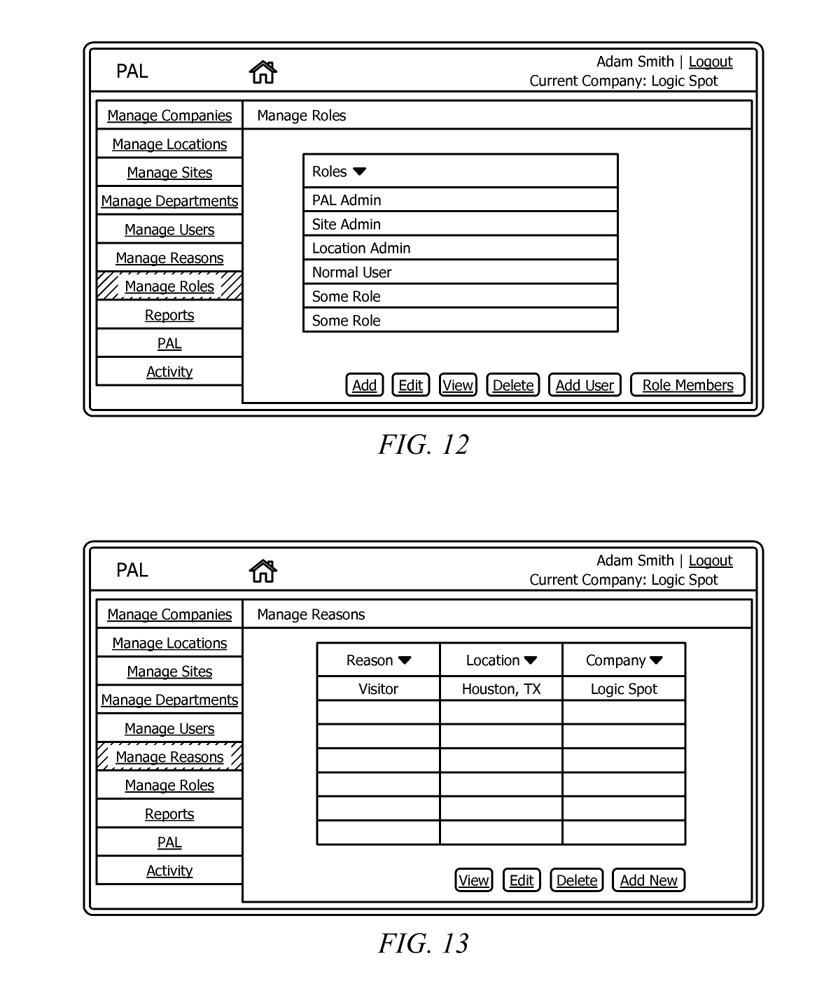

Looking at FIG. 12, illustrated is a screen shot of an exemplary list of roles of one or more users within a subscriber's organization that may be included in a PAL system or network in accordance with the disclosed principles. As illustrated, exemplary roles for persons accessing the displayed PAL system page may be provided to the viewer of the page. As any particular role is selected, a list of users having the selected role(s) may be displayed. Users are assigned particular roles, and within those particular roles their permission level to various areas within the PAL system is defined. For example, a Default roles may only provide a user basic access to Check In/Out only, but no administrative access or other special permissions. Other roes could be Administrator or Site Administrator, each role with its unique permissions and access. Moreover, the person accessing the illustrated page may also be permitted to assign roles to particular user, if needed. Furthermore, information regarding the roles of each user may be edited, added to, or deleted, as with other items discussed herein. Also, such roles may also be provided for other types of assets being accounted for, such as equipment. In such embodiments, similar advantages to those provided for a list of personnel roles may also be provided.

Looking at FIG. 13, illustrated is a screen shot of an exemplary list of reasons a user within a subscriber's organization may be found at a given location that may be included in a PAL system or network in accordance with the disclosed principles. Just as with lists of roles that may be presented to authorized persons, a list of reasons that selected users may have within an organization, or perhaps the role that each user is in when visiting a subscriber's location, site, department, etc. Also, such a list of reasons could also be provided for equipment or other assets accounted for by the PAL system. As before, the person accessing this list of reasons may also be permitted to assign reasons to particular users or equipment, if needed, and may even be permitted edit, added to, or delete specific reasons for selected assets. In addition, Reasons may be customizable for each subscribing company, etc., and can be as detailed as needed. Such customized information would also assist in accountability situations, for example, for use by first responders looking to account for all persons at a particular location.

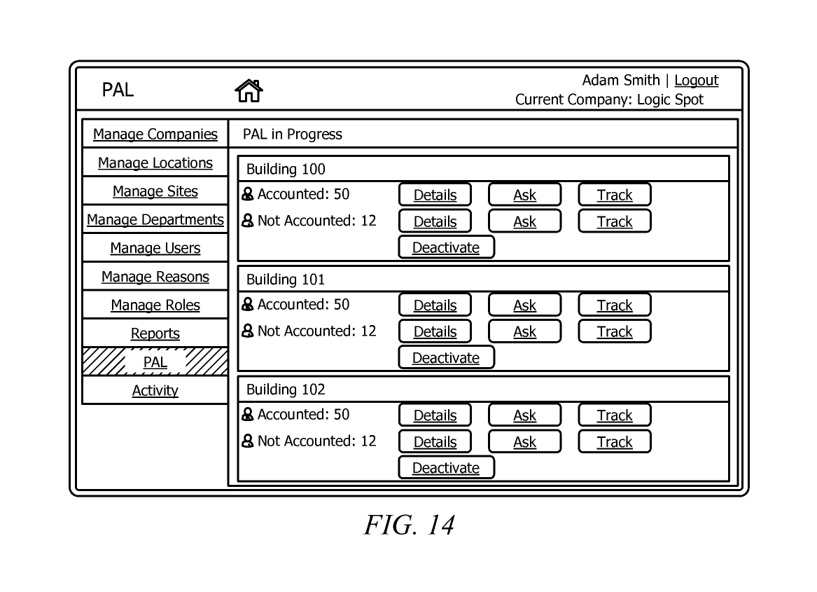

Looking at FIG. 14, illustrated is a screen shot of exemplary accountability information provided for a given subscriber of a PAL system or network in accordance with the disclosed principles. Specifically, the exemplary screen illustrates three distinct buildings of a subscriber's location or locations, and the accountability of personnel associated with those buildings that may be provided by the disclosed principles. In this embodiment, the PAL process has been activated for these buildings, and thus the authorized person viewing the illustrated page is provided with an accounting of the users registered with the PAL system and that have checked-in or checked-out of the site. As shown, in all three buildings, 50 users have been accounted for in some manner, and 12 users have not.

How each user has been accounted for may also be provided to the viewer of the page, such as by selecting the details button. Such detailed information may indicate the individual identification of the accounted for, or unaccounted for, users, as well as any other identifying information that may be stored in the PAL system and accessible to the viewer of the page. Additionally, the viewer may also select an Ask button, which may be used to make predetermined inquiries of registered users, or even may permit custom inquiries to be entered into the application and sent to users. Since the disclosed principles teach that users have mobile devices running a PAL system application in such embodiments, such inquires may be directly sent to selected users, or even all users simultaneously. Furthermore, each user may also be tracked by the viewer by selecting a Track button. Such tracking may be provided by indicating on a map the location of each user (e.g., using GPS technology from users' mobile devices), or a trail of select users may be tracked using timestamps used in coordination with various user Check Ins/Outs, GPS information from mobile devices, information from local detection networks, or any other technique employed by a PAL system to account for the locations and/or functions of registered users. Moreover, all of the above-described features can be applied for other types of monitored assets beyond personnel.

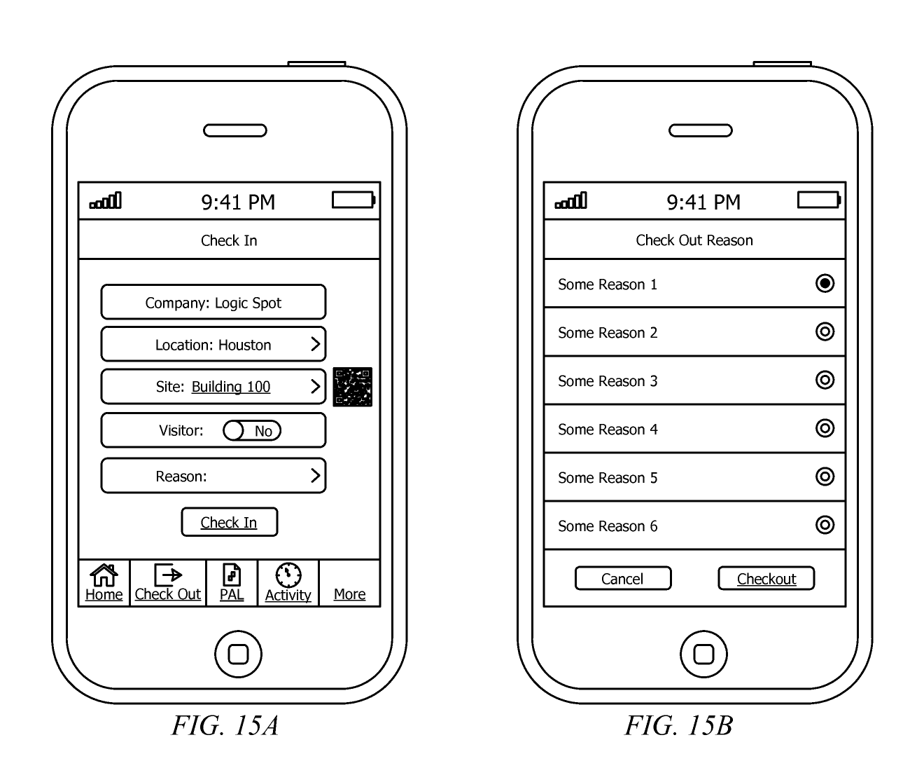

FIGS. 15A & 15B illustrate a mobile device running an application for use by a user registered with a PAL system or network in accordance with the disclosed principles, and displaying exemplary Check In and Check Out functions of such an application. Specifically, as disclosed herein, application modules are employed with a PAL system or network to communicate with data centers within the network. The devices executing the applications are associated with the assets, either persons or equipment, or even with locations, whose accountability is provided for by the system. In these figures, the asset is a user and the application is running on a user's mobile telephone. Other user mobile devices may also be employed, as discussed herein.

In FIG. 15A, the application is providing an exemplary Check In screen that may be presented to a user of the mobile telephone. In accordance with the disclosed principles for a PAL system or network, user Check In may be prompted in a variety of ways. For example, as the user arrives at a location included in a PAL network, the user may employ his mobile telephone to scan or otherwise enter a unique identifier, such as a QR code, associated with the location into the application. In other embodiments, the user may scan his own unique code, for example, if generated at a station associated with the location he is visiting. Alternatively, the user may enter the unique identifier or location manually, if scanning is not available. Still further, the location may have a local detection network in place that detects the presence of the mobile telephone via the application within a predetermined distance of the location. In such embodiments, the application may initiate the Check In process upon detection or even upon receiving a signal from the local detection network. In other embodiments, the GPS location of the mobile device may be monitored by the PAL system mobile application, while the GPS location of the registered location may be stored in the PAL system, and thus the application could detect when the location of the mobile device is within a predetermine distance of the location. Other means of initiating the Check In function of the application may also be employed, and each such method is still within the broad scope of the disclosed principles.

The information provided via the Check In screen may also be any type of beneficial information for the PAL system. In the illustrated example, the name of the subscribing company is displayed, as is the physical address of the company or location/site within the company where the user is checking in. Additionally, the application may allow the user to indicate whether he is a visitor at the check in location. In some embodiments, if the user's identification information is available to the application, the application could determine if the user is at his “home” location, and thus is not a visitor. Furthermore, in this example, the user may also select or otherwise enter a reason for his arrival at the location. As before, such a reason may be automatic, such as if the user is simply checking in at his home location, in which case the application could default the reason for the user's presence there as “workday” or other similar designation. Once any selectable information has been designated by the user or automatically provided by the application, the user can select a manual Check In button to execute his checking in to the specific location.

When the user has finished his stay at the location at which he is checked in, the application may also provide a Check Out feature to the user, a screen shot of which is illustrated in FIG. 15B. When the Check Out function of the application is initiated, the user may also be prompted to select a reason he is leaving the location. In some embodiments, the reason for checking out from the location may be automatic, such as when the location is simply the workplace (or other “home” location) of the user. As with the Check In function of the mobile device application, the Check Out function may be initiated in any of a number of ways. For example, the user may manually initiate the function when leaving a location, or the function may automatically initiate when the mobile devices leaves a predetermined distance from the checked in location. As before, such detection may occur with a local detection network at the checked in location, or a may be determined based on the GPS location of the mobile device in relation to the stored GPS location of the checked in location. Of course, other detection means may also be employed with the disclosed principles.

As discussed herein, the user's check in information, which could include the location, reason for visit, and timestamp for the check in, among any other useful information, may then be logged with a PAL system data center. Similarly, the user's Check Out information could include the location of the check out, the reason for checking out, and a timestamp for the check out. An administrator or other authorized personnel could then access such accountability information when needed, and the accountability of the user could then be provided via the PAL system. As discussed above, such accountability information could include the identification information of the user, the date and time of his check in/out, the specific location of his check in/out, and even the reason for his visit. Additionally, when combined with a Check Out from a previous location, the accountability information could also then provide the prior location information, as well as the time between the two location visits, to help monitor travel efficiency or any other useful information regarding the user's travel between PAL network locations.

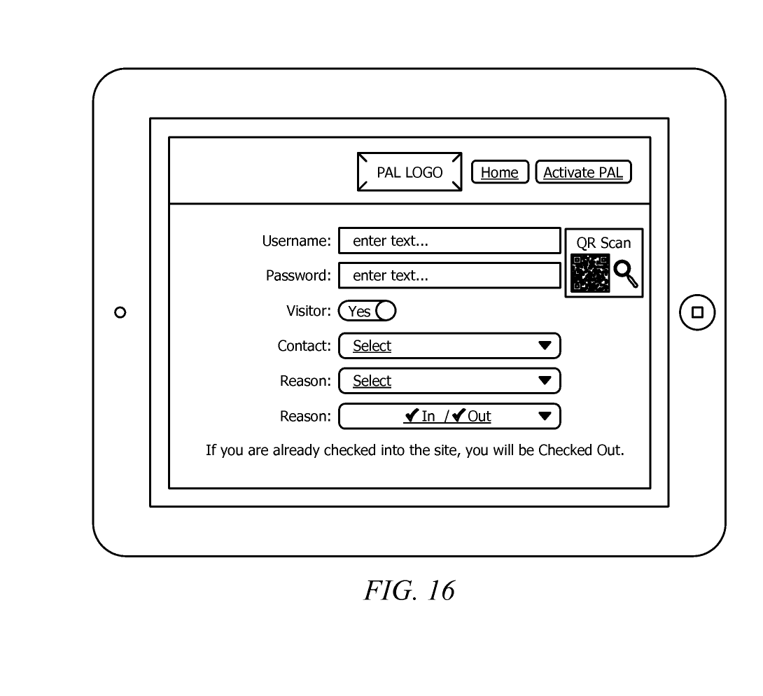

FIG. 16 illustrates an exemplary computing device that may be provided at a location or equipment registered with a PAL system in accordance with the disclosed principles. More specifically, such a computing device may execute a PAL system application, similar to the mobile device application discussed with reference to FIGS. 15A and 15B. However, in this embodiment of the disclosed principles, a registered user may perform a Check In or Check Out function using this computing device, which is fixed to the location, equipment, etc. registered with the PAL system, rather than via his mobile device application.

More specifically, the user may enter his unique identifier, or other unique identifying information identifying the user, into the application running on the fixed computing device. As illustrated, this may include a username and password. Additionally, the user may be prompted to enter other Check In/Out information, such as information of the type entered via his mobile device in the previously discussed embodiment. For example, the user may be prompted to enter the contact person he is visiting, if the fixed computing device is at a location, and the user may be prompted to enter a reason for his visit to the location. In other embodiments, if the computing device is associated with a vehicle or other piece of equipment, the user could be prompted to enter his intended use of the equipment, and perhaps even when he will be finished using the equipment for that stated purpose. Of course, other useful information may also be prompted for from the user.

Moreover, rather than manually entering such Check In (or Check Out) information, the user may also simply use the fixed computing device to scan or otherwise read the user's own unique identifier. In this illustrated embodiment, the user could select the “QR Scan” button, and then provide his unique QR code to the fixed device for scanning The user's QR code could be provided on a physical badge or other tangible means, or it may be provided on the display of his mobile device or by other electronic means. Upon such a scan, the identifying information of the user would be retrieved by the computing device from a data center based on the scan of the unique code or other identifier assigned to the user. Accordingly, in these embodiments, instead of the mobile application associated with the user obtaining identification information and thereafter sending and receiving accountability information to and from a data center, an application associated with a computing device affixed to a location, equipment, etc. is used to obtain identification information and thereafter send and receive accountability information to and from a data center. In either approach, the principles disclosed herein provide for a remote application to work with a data center across a public communications network to identify assets, such as users, equipment, etc., and to provide accountability information on registered assets to the data center. The accountability information may then be accessed by authorized personnel or other applications to establish the identity and accountability of assets registered with the PAL system.

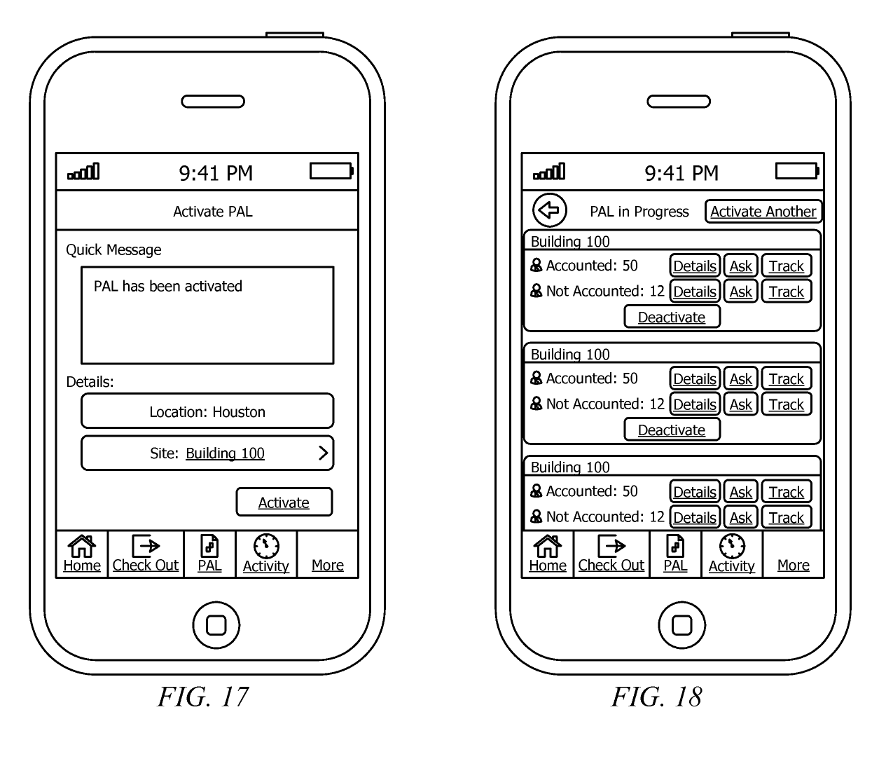

FIG. 17 illustrates a mobile device running an application for use by a user registered with a PAL system or network in accordance with the disclosed principles, and displaying an exemplary PAL Activation function of the application. Such an activation process may be used in a number various ways. For example, the user of the mobile device may elect to activate the PAL process on his device as he approaches a specific location of a subscriber to the PAL system. Moreover, the application may automatically prompt the user with the PAL activation screen as the application detects the mobile device is within a predetermined distance of a PAL system location, equipment, etc. Such detection technique could be in any of the ways discussed above.

Still further, the user may be activating the PAL process on his mobile device because he is attempting to gather accountability information on an asset, such as another user or a piece of registered equipment. In such embodiments, the user, after activating the PAL process on his mobile device, may then select a specific location, and even a particular site or building within that location, on which he would like to view accountability information. Such an embodiment would be particularly useful for a supervisor of other users or equipment, and thus would allow the supervisor to use their mobile device to quickly and easily obtain accountability information on assets registered with the PAL system.

Alternatively, the details gathered by the mobile application and displayed on the mobile device may simply be the specific information regarding a location the user is near. The user could then confirm or perhaps even edit such information before checking in or out with the PAL system. The application may even be configured to permit the user to provide a message or other custom information to the PAL system, which may then be added to the accountability information stored in the system. Of course, other features and functionality for gathering or obtaining accountability information with the mobile application may also be provided in accordance with the disclosed principles.

FIG. 18 illustrates a mobile device running an application for use by a user registered with a PAL system or network in accordance with the disclosed principles, and displaying exemplary accountability information of a PAL system via the application. The exemplary mobile application screen illustrates three distinct buildings of a subscriber's location or locations, and the accountability of personnel associated with those buildings that may be provided by the disclosed principles. In this embodiment, the PAL process has been activated for these buildings, and thus the authorized person viewing the mobile device is provided with an accounting of the users registered with the PAL system, and associated with these specific locations. As shown, in all three buildings 50 users have been accounted for in some manner, and 12 users have not.

How each user has been accounted for may also be provided to the viewer of the page, such as by selecting the Details button. Such detailed information may indicate the individual identification of the accounted for, or unaccounted for, users, as well as any other identifying information that may be stored in the PAL system and accessible to the viewer of the page. Additionally, the viewer may also select an Ask button, which may be used to make predetermined inquiries of registered users, or even may permit custom inquiries to be entered into the system and sent to users. Since users may have mobile devices running a PAL system application, such inquires may be directly sent to selected users, or even all users simultaneously. Furthermore, each user may also be tracked by the viewer by selecting a Track button. Such tracking may be provided by indicating on a map the location of each user (e.g., using GPS technology from users' mobile devices), or a trail of select users may be tracked using timestamps used in coordination with various user Check Ins/Outs, GPS information from mobile devices, information from local detection networks, or any other technique employed by a PAL system to account for the locations and/or functions of registered users.

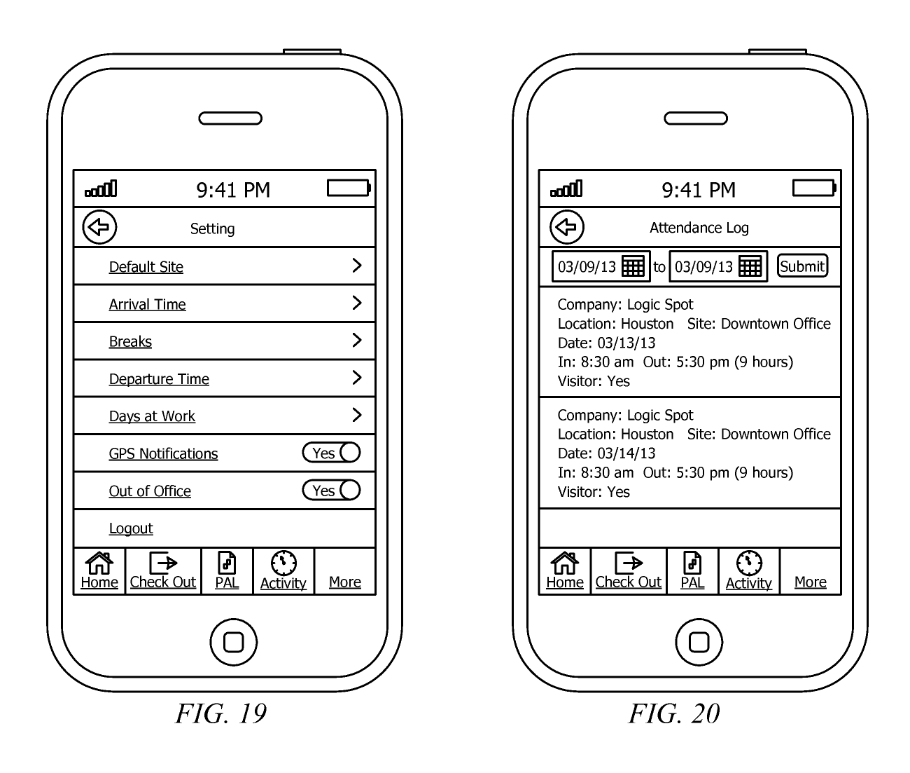

FIG. 19 illustrates a mobile device running an application for use by a user registered with a PAL system or network in accordance with the disclosed principles, and displaying exemplary settings that may be set by a user of the application. More specifically, the illustrated page provided by the PAL mobile application allows a user to establish individualized accountability information specific to him. For example, the application may allow the user to establish a Default Site that he is typically located at or otherwise affiliated with. Such a site could be the location, site, building, etc. that the user is typically found during a normal workday.

Additionally, the application may allow the user to establish a schedule related to the user's typical day so that other users, administrators, etc. of the PAL system may account for the user at any given time. Accordingly, as other users, administrators, or other authorized persons employ the PAL system to account for the user's whereabouts at any given time, the user's established default information is stored by the data center and provided to such authorized persons. Moreover, as the user varies from his default location or schedule, the user's mobile device application can be used as disclosed herein to update the user's accountability information. As a result, if no update to the user's default accountability information is made via the PAL system, that default information can be provided to authorized persons to account for the user's location and/or activities. As updates are made, which can be for any number of reasons such as the user visiting another location or site, that new information is obtained by the data center for use in accounting for the user's whereabouts and activities, if sought.

As shown in FIG. 19, exemplary information regarding the user's schedule that may be entered could include the user's daily arrival and departure times at his default location, as well as scheduled daily breaks. The application may also allow the user to enter to days the user may be found at the default location, and whether the user is currently not at the default location. Furthermore, the application may allow the user to select whether he would like the application to provide GPS information to the PAL system via his mobile device. Of course, other accountability information may also be provided via a mobile application as disclosed herein, and the information illustrated in FIG. 19 is merely exemplary.

FIG. 20 illustrates a mobile device running an application for use by a user registered with a PAL system or network in accordance with the disclosed principles, and displaying an exemplary log having accountability information that may be accessed with the application. More specifically, the illustrated log is an Attendance Log, which provides an accounting for a user's presence at a particular location.

As shown, the log can inform authorized personnel of the date(s) and time(s) the subject user was at a particular location or site of a subscribing company. In addition, this accountability information also indicates that the user was at that particular location, on those days and at those times, in the capacity of a visitor. Such a log would be useful for an administrator or supervisor to confirm that the user was actually visiting the location he was scheduled to be at, and for the day(s) and time(s) he was scheduled to be there. Alternatively, such an attendance log may be for account for the daily workdays of employees. In such embodiments, the capacity of the monitored user may not be a visitor since he would simply be arriving each day as an employee. By implementing the disclosed PAL system in this manner, the days and times that the user was actually at his work location can be monitored and confirmed.

In all of these various embodiments, user Check In/Outs may be performed in any advantageous manner. For example, in embodiments where the monitored user is an employee at his default work location, the user's entry and exit to and from his building, department, or office can be provided using by the user scanning a unique identifier with his mobile device and application, or providing a unique identifier to be scanned with a fixed computing device at the location, when the user enters or exits. Alternatively, a local detection network, perhaps based on GPS information, may also be employed with a user's mobile device running a PAL application to account for the user's entry and exit to the location. Regardless of the specific means for logging the user's presence at the location, the disclosed principles provide for the storing of the users' accountability information with a centralized data center using a typical, publicly available communications network, as discussed in detail herein. That information may then be accessed by administrators or other authorized persons by simply having access to an available communications network as discussed in detail above.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A networked accountability system for providing accountability information for mobile assets associated with a plurality of entities, the system comprising:
a plurality of visibly decipherable asset identifiers, unique to and created by the system, assigned to and configured to identify each corresponding mobile asset;
a plurality of visibly decipherable location identifiers, unique to and created by the system, assigned to and configured to identify each of a plurality of corresponding physical locations;
a database connected to a communications network and configured to store:
accountability data for the mobile assets,
data regarding each of the mobile assets' unique asset identifier, and
data regarding each of the unique location identifiers;
a plurality of applications executed on a corresponding plurality of computing devices, each application configured to communicate with the database using the communications network and to associate one of the unique location identifiers associated with a respective one of the plurality of physical locations with an asset identifier of a mobile asset when the mobile asset is located at the respective one of the plurality of physical locations; and
an interface in communication with the database and accessible by authorized users to obtain accountability information regarding one or more of the mobile assets;
wherein the database is configured to receive accountability data regarding the mobile assets from the plurality of applications and to provide the accountability information via the interface in response to an authorized user's accountability inquiry regarding one or more of the mobile assets.

2. A networked accountability system in accordance with claim 1, wherein at least one of the mobile assets comprises a person.

3. A networked accountability system in accordance with claim 2, wherein at least one of the plurality of applications is running on a mobile computing device associated with the person.

4. A networked accountability system in accordance with claim 3, wherein the mobile computing device is configured to capture the unique location identifier of one of the plurality of physical locations, the application running on the mobile computing device providing accountability data regarding the person across the communications network.

5. A networked accountability system in accordance with claim 4, wherein the accountability data comprises one or more of a timestamp the person arrives at or departs the physical location, a reason the person is at the physical location, a period of time the person is at the physical location, or a period of time the person will not be at the physical location.

6. A networked accountability system in accordance with claim 4, wherein the computing device comprises a mobile telephone.

7. A networked accountability system in accordance with claim 1, wherein at least one of the plurality of physical locations comprises a specific geographically determined position.

8. A networked accountability system in accordance with claim 7, wherein the at least one of the plurality of physical locations comprises a structure at the position.

9. A networked accountability system in accordance with claim 8, wherein the at least one of the plurality of physical locations comprises a department within the structure.

10. A networked accountability system in accordance with claim 7, wherein at least one of the plurality of applications is running on a computing device associated with the physical location.

11. A networked accountability system in accordance with claim 10, wherein the computing device is configured to capture the unique asset identifier of one of the mobile assets, the application running on the computing device providing accountability data regarding the mobile asset across the communications network.

12. A networked accountability system in accordance with claim 11, wherein the accountability data comprises one or more of a timestamp a mobile asset arrives at or departs the physical location, a reason a mobile asset is at the physical location, a period of time a mobile asset is at the physical location, or a period of time a mobile asset will not be at the physical location.

13. A networked accountability system in accordance with claim 11, wherein the mobile asset is a person, and the unique asset identifier is the person's username and password.

14. A networked accountability system in accordance with claim 1, wherein at least one of the mobile assets comprises equipment for use by persons.

15. A networked accountability system in accordance with claim 14, wherein one of the plurality of applications is configured to capture the unique asset identifier of the equipment, the one of the plurality of applications providing accountability data regarding the equipment across the communications network.

16. A networked accountability system in accordance with claim 15, wherein the one of the plurality of applications is running on a mobile computing device associated with a person having a unique asset identifier distinct from the unique asset identifier of the equipment.

17. A networked accountability system in accordance with claim 16, wherein the accountability data comprises one or more of a timestamp the equipment is placed in the custody of the person, a reason the equipment is in the custody of the person, a period of time the equipment will be in the custody of the person, or timestamp the equipment is no longer in the custody of the person.

18. A networked accountability system in accordance with claim 15, wherein the one of the plurality of applications is running on a computing device associated with one of the plurality of physical locations.

19. A networked accountability system in accordance with claim 18, wherein the accountability data comprises one or more of a timestamp the equipment is brought to or removed from the one of the plurality of locations, a reason the equipment is brought to or removed from the one of the plurality of locations, a period of time the equipment is at the one of the plurality of locations, or a period of time the equipment will be removed from the one of the plurality of locations.

20. A networked accountability system in accordance with claim 1, wherein the unique asset identifiers and the unique location identifiers comprise unique codes.

21. A networked accountability system in accordance with claim 20, wherein the unique codes are QR codes specific to each mobile asset and physical location.

22. A networked accountability system in accordance with claim 1, wherein the communications network is the Internet.

23. A networked accountability system in accordance with claim 1, wherein the communications network is a telephone communications network.

24. A networked accountability system for providing accountability information for mobile assets associated with a plurality of entities, the system comprising:
a data center connected to a communications network and configured to store identification data and accountability data regarding the mobile assets in relation to physical locations associated with the entities;
a unique visibly decipherable identifier, each unique to and created by the system, assigned to each mobile asset and to each physical location, wherein each unique identifier comprises identifying data corresponding to each mobile asset or physical location;
a plurality of applications each running on a corresponding plurality of computing devices configured to communicate using the communications network and associated with corresponding mobile assets, wherein each application is configured to capture a unique identifier associated with a physical location and gather accountability data regarding each application's corresponding mobile asset in relation to that physical location; and
an interface in communication with the data center and accessible by authorized users to obtain accountability information regarding one or more of the mobile assets;
wherein the data center is configured to receive accountability data regarding mobile assets from the applications across the communications network, and to provide the accountability information across the communications network in response to an authorized user's accountability inquiry regarding one or more of the mobile assets.

25. A networked accountability system for providing accountability information for mobile assets associated with a plurality of entities, the system comprising:
a data center connected to a communications network and configured to store identification data and accountability data regarding mobile assets in relation to physical locations associated with the entities;
a unique visibly decipherable identifier, each unique to and created by the system, assigned to each mobile asset and to each physical location, wherein each unique identifier comprises identifying data corresponding to each mobile asset or physical location;
a plurality of applications running on a corresponding plurality of computing devices configured to communicate using the communications network and associated with corresponding physical locations, wherein each application is configured to capture a unique identifier associated with a mobile asset and gather accountability data regarding each application's corresponding mobile asset in relation to that physical location; and
an interface in communication with the data center and accessible by authorized users to obtain accountability information regarding one or more of the mobile assets;
wherein the data center is configured to receive accountability data regarding mobile assets from the applications across the communications network, and to provide the accountability information across the communications network in response to an authorized user's accountability inquiry regarding one or more of the mobile assets.
